(19) United States
(12) Patent Application Publication
(10) Pub. No.: US 2019/0368674 A1
(43) Pub. Date: Dec. 5, 2019

(54) Environmentally-Friendly Street Light with Multi-stage Gear Drive Using Public Seat Gravity Energy to Generate Electricity

(71) Applicant: Chi Wan YEUNG, Hong Kong (HK)

(72) Inventor: Chi Wan YEUNG, Hong Kong (HK)

(21) Appl. No.: 16/108,084

(22) Filed: Aug. 21, 2018

(30) Foreign Application Priority Data
May 31, 2018 (CN) 201810546637.9

(51) Int. Cl. F21S 9/04; F21S 8/08; H02N 2/18; F03G 7/10; F03G 7/08; H02N 2/12; A47C 3/26

(52) U.S. Cl. CPC F21S 9/04; F21S 8/086; H02N 2/18; F21W 2131/301; F03G 7/08; H02N 2/123; A47C 3/26; F03G 7/10

(57) ABSTRACT

The invention relates to an environmentally-friendly street light with a multi-stage gear drive to generate electricity by using the public seat gravity potential energy which includes a base plate, a plurality of lifting seats surrounding the circumference of the base plate, a light pole and a light disposed on the base plate, power generating devices respectively corresponding to the lifting seats, and a storage battery. The bottom of the lifting seat is provided with a rebound device for raising the lift seat, and a one-way driving strip is disposed on the rear side of the lift seat. The power generating device includes a first power generating device and a second power generating device. The first power generating device includes a first shifting gear set that transmits to connect to the one-way driving strip, and a first power generator. The street light has a reasonable structure, and can utilize and store the electric energy converted by the gravity potential energy generated when the human body sits down. It saves energy and reduces pollution, and is beneficial to environmental protection.

### FIELD OF THE INVENTION

The invention relates to an environmentally-friendly street light. In particular, the invention relates to an environmentally-friendly street light with multi-stage gear drive using public seat gravity energy to generate electricity.

### BACKGROUND

Energy conservation is an important social awareness in today's world. Energy conservation refers to a series of actions that reduce energy consumption and increase energy utilization as much as possible. Street lights that are provided with electricity by using solar and wind power are currently available; however, such energy sources are unstable. At the time of continuous rainy weather and windless weather, street lights cannot be powered. In the process of urbanization, people need more electricity to develop industries, decorate cities and achieve home electrification. All of these have a constant new demand for electricity. On the other hand, a large amount of carbon dioxide will be released by using coal to generate electricity, which has a direct impact on the atmospheric environment. Therefore, how to use natural energy, such as wind, solar, potential energy, etc. to alleviate electricity demand and protect the environment has become our focus.

### SUMMARY OF THE INVENTION

The technical problem to be solved is to overcome the above-mentioned deficiency by providing an environmentally-friendly street light with a multi-stage gear drive to generate electricity by using the public seat gravity potential energy. The street light has a reasonable structure, and can utilize and store the electric energy converted by the gravity potential energy generated when the human body sits down. It saves energy and reduces pollution, and is beneficial to environmental protection.

The technical solution of the present invention is to provide an environmentally-friendly street light with a multi-stage gear drive to generate electricity by using the public seat gravity potential energy which includes a base plate, a plurality of lifting seats surrounding the circumference of the base plate, a light pole and a light disposed on the base plate, power generating devices respectively corresponding to the lifting seats, and a storage battery. The bottom of the lifting seat is provided with a rebound device for raising the lift seat, and a one-way driving strip is disposed on the rear side of the lift seat.

The power generating device includes a first power generating device and a second power generating device. The first power generating device includes a first shifting gear set that transmits to connect to the one-way driving strip, and a first power generator. The second power generating device includes a gravity driving strip disposed on the inner cavity of the light pole, a second shifting gear set that transmits to connect to the gravity driving strip, a second power generator and a rising mechanism for lifting the gravity driving strip.

The one-way driving strip and the back side of the gravity driving strip are respectively hinged with a plurality of one-way ratchets and a groove for mounting the one-way ratchet.

The first shifting gear set and the second shifting gear set are respective a four-stage shifting gear set which consists of a first double-linking gear, a second double-linking gear, a third double-linking gear and a fourth double-linking gear. The first double-linking gear and the third double-linking gear are coaxially arranged. The second double-linking gear and the fourth double-linking gear are coaxially arranged. The input gear of the first double-linking gear is a ratchet wheel structure which meshes with the one-way driving strip. The output gear of the fourth double-linking gear transmits to connect to the first power generator and the second power generator, respectively.

The rising mechanism includes a fixed pulley, a guiding pulley, a one-way reel and a pulling rope disposed at an upper portion of the inner cavity of the light pole. The pulling rope sequentially winds the fixed pulley and the guiding pulley, and the two ends of the pulling rope are respectively connected with the gravity driving strip and the one-way reel. The one-way reel is disposed at the bottom of the one-way driving strip. The side of the one-way reel is provided with a ratchet wheel that is mutually driven with the one-way ratchet on the one-way driving strip.

In a preferred embodiment, the rebound device is a spring rebound or cylinder rebound device.

In a preferred embodiment, the gravity driving strip is sildingly mounted on a guide sleeve disposed in the base plate.

In a preferred embodiment, the bottom of the gravity driving strip is provided with a weight.

The technical effect of the invention to provide an environmentally-friendly street light with a multi-stage gear drive to generate electricity by using the public seat gravity potential energy with a reasonable structure. It includes a first power generating device and a second power generating device. It utilized the gravitational potential energy generated when the human body sits down to convert to electric power, which turns on the street lights. After the human body leaves the seat, the street light will not be extinguished immediately, and the street light can be continuously powered for a period of time. When the human body sits down, the first power generating device operates to supply power to the street light, the gravity driving strip of the second power generating device rises and stores the gravitational potential energy. When the human body leaves the seat, the ratchet wheel is separated from the one-way driving strip, and the gravity driving strip begins to drive the second power generating device to continue to supply power the street light. The one-way driving strip and the back side of the gravity driving strip are respectively hinged with a plurality of one-way ratchets. When the one-way driving strip and the gravity driving strip move downward, the one-way ratchet transmits to be connected with the first double-linking gear so as to drive the first power generating device and the second power generating device. When the human body leaves the seat, the seat is restored to the original position under the action of the rebound device. The seat is not transmissibly connected to the one-way ratchet at the time of rising, and is able to go back to original position soon. The invention saves energy and has no pollution and is beneficial to the environmental protection, the position is restored, the rising process is not driven by the one-way ratchet, and the position can be quickly restored, energy saving and emission reduction, no pollution, and environmental protection.

### BRIEF DESCRIPTION OF THE DRAWINGS

The invention is illustrated by the following figures and embodiments.

FIG. 1 shows a schematic diagram of whole structure of an environmentally-friendly street light with a multi-stage gear drive to generate electricity by using the public seat gravity potential energy in accordance with one embodiment.

FIG. 2 shows a schematic diagram of the inside of an environmentally-friendly street light with a multi-stage gear drive to generate electricity by using the public seat gravity potential energy in accordance with one embodiment.

FIG. 3 shows a schematic diagram of a power generating device of an environmentally-friendly street light with a multi-stage gear drive to generate electricity by using the public seat gravity potential energy in accordance with one embodiment.

FIG. 4 shows a schematic diagram of a shifting gear set of an environmentally-friendly street light with a multi-stage gear drive to generate electricity by using the public seat gravity potential energy in accordance with one embodiment.

FIG. 5 shows a schematic diagram of a one-way reel of an environmentally-friendly street light with a multi-stage gear drive to generate electricity by using the public seat gravity potential energy in accordance with one embodiment.

The reference numbers of the figures are as follows:

1: base plate; 2: lifting seat; 21: one-way driving strip; 211: one-way ratchet; 22: groove; 3: light pole; 4: light; 40: first generator; 41: second generator; 51: first double-linking gear; 52: second double-linking gear; 53: third double-linking gear; 54: four double-linking gear; 6: gravity driving strip; 61: guide sleeve; 62: weight; 7: fixed pulley; 70: guiding pulley; 71: one-way reel; 711: ratchet; 72: pulling rope.

### DETAILED DESCRIPTION

The invention is illustrated in accordance with figures. The figures as simplified diagrams demonstrate the basic structures of the apparatus of embodiments of the invention. Thus, the invention is not limited to the figures.

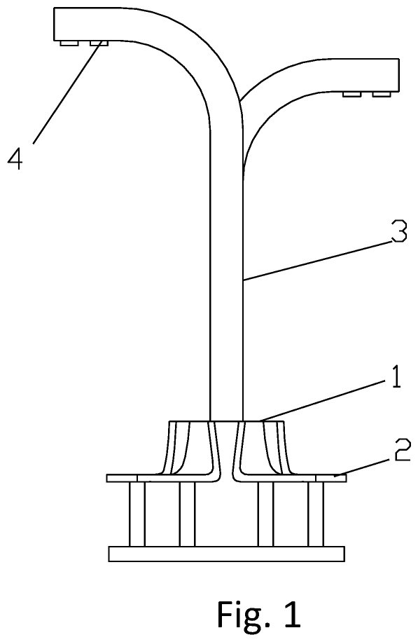

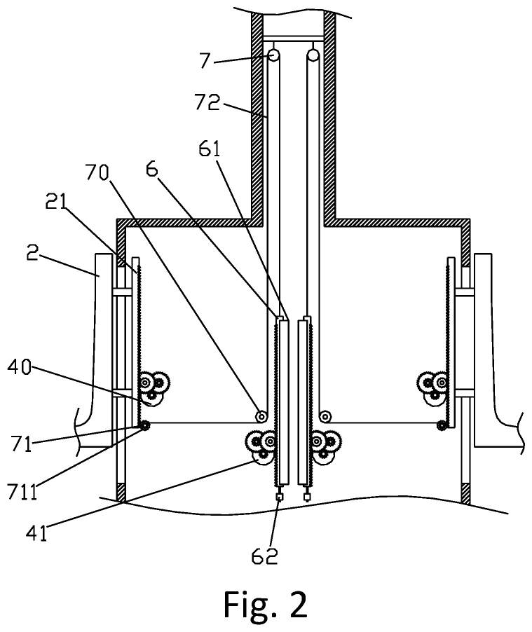

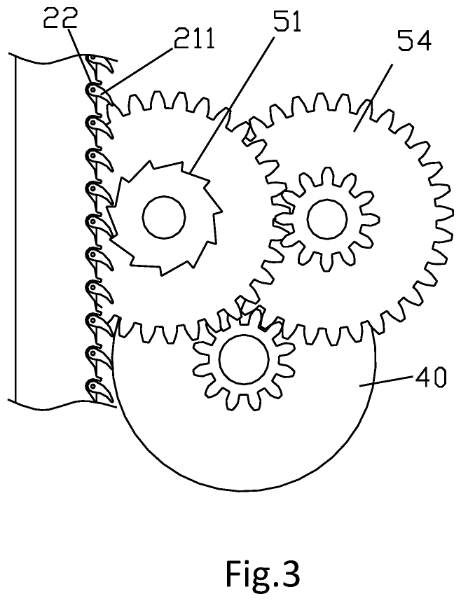

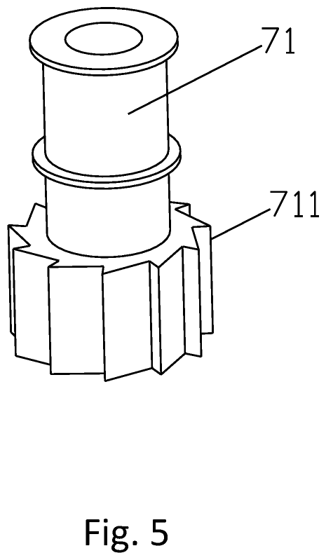

As shown in FIGS. 1, 2, 3 and 5, an environmentally-friendly street light with a multi-stage gear drive to generate electricity by using the public seat gravity potential energy includes a base plate 1, a plurality of lifting seats 2 surrounding the circumference of the base plate 1, a light pole 3 and a light 4 disposed on the base plate 1, power generating devices respectively corresponding to the lifting seats 2, and a storage battery. The bottom of the lifting seat 2 is provided with a rebound device for raising the lift seat 2, and a one-way driving strip 21 is disposed on the rear side of the lift seat 2. The power generating device includes a first power generating device and a second power generating device. The first power generating device includes a first shifting gear set that transmits to connect to the one-way driving strip 21, and a first power generator 40. The second power generating device includes a gravity driving strip 6 disposed on the inner cavity of the light pole 3, a second shifting gear set that transmits to connect to the gravity driving strip 6, a second power generator 41 and a rising mechanism for lifting the gravity driving strip 6. The one-way driving strip 21 and the back side of the gravity driving strip 6 are respectively hinged with a plurality of one-way ratchets 211 and a groove 22 for mounting the one-way ratchet 211. The rising mechanism includes a fixed pulley 7, a guiding pulley 70, a one-way reel 71 and a pulling rope 72 disposed at an upper portion of the inner cavity of the light pole 3. The pulling rope 72 sequentially winds the fixed pulley 7 and the guiding pulley 70, and the two ends of the pulling rope 72 are respectively connected with the gravity driving strip 6 and the one-way reel 71. The one-way reel 71 is disposed at the bottom of the one-way driving strip 21. The side of the one-way reel 71 is provided with a ratchet wheel 711 that is mutually driven with the one-way ratchet 211 on the one-way driving strip 21.

The rebound device is a spring rebound or cylinder rebound device. The gravity driving strip 6 is sildingly mounted on a guide sleeve 61 disposed in the base plate 1. The bottom of the gravity driving strip 6 is provided with a weight 62.

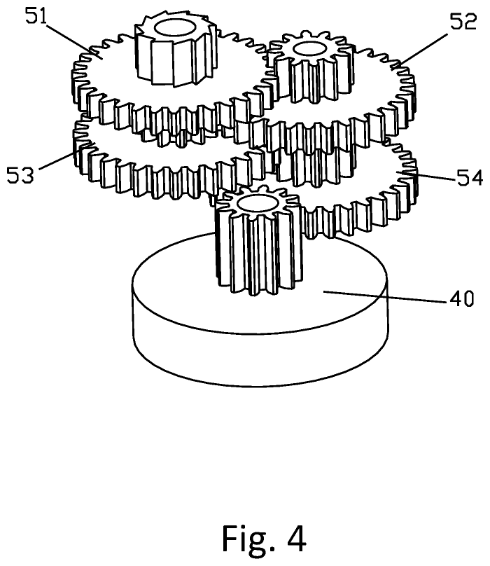

As shown in the environmentally-friendly street light with a multi-stage gear drive to generate electricity by using the public seat gravity potential energy of FIG. 4, the first shifting gear set and the second shifting gear set are respectively a four-stage shifting gear set which consists of a first double-linking gear 51, a second double-linking gear 52, a third double-linking gear 53 and a fourth double-linking gear 54. The first double-linking gear 51 and the third double-linking gear 53 are coaxially arranged. The second double-linking gear 52 and the fourth double-linking gear 54 are coaxially arranged. The input gear of the first double-linking gear 51 is a ratchet wheel structure which meshes with the one-way driving strip 21. The output gear of the fourth double-linking gear 54 transmits to connect to the first power generator 40 and the second power generator 41, respectively.

The environmentally-friendly street light with a multi-stage gear drive to generate electricity by using the public seat gravity potential energy of the present invention has a reasonable structure. It includes a first power generating device and a second power generating device. It utilized the gravitational potential energy generated when the human body sits down to convert to electric power, which turns on the street lights. After the human body leaves the seat, the street light will not be extinguished immediately, and the street light can be continuously powered for a period of time. When the human body sits down, the first power generating device operates to supply power to the street light, the gravity driving strip of the second power generating device rises and stores the gravitational potential energy. When the human body leaves the seat, the ratchet wheel is separated from the one-way driving strip, and the gravity driving strip begins to drive the second power generating device to continue to supply power the street light. The one-way driving strip and the back side of the gravity driving strip are respectively hinged with a plurality of one-way ratchets. When the one-way driving strip and the gravity driving strip move downward, the one-way ratchet transmits to be connected with the first double-linking gear so as to drive the first power generating device and the second power generating device. When the human body leaves the seat, the seat is restored to the original position under the action of the rebound device. The seat is not transmissibly connected to the one-way ratchet at the time of rising, and is able to go back to original position soon. The invention saves energy and has no pollution and is beneficial to the environmental protection, the position is restored, the rising process is not driven by the one-way ratchet, and the position can be quickly restored, energy saving and emission reduction, no pollution, and environmental protection.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An environmentally-friendly street light with a multi-stage gear drive to generate electricity by using the public seat gravity potential energy, comprising: a base plate 1, a plurality of lifting seats 2 surrounding the circumference of the base plate 1, a light pole 3 and a light 4 disposed on the base plate 1, power generating devices respectively corresponding to the lifting seats 2, and a storage battery,
wherein the bottom of the lifting seat 2 is provided with a rebound device for raising the lift seat 2, and a one-way driving strip 21 is disposed on the rear side of the lift seat 2;
wherein the power generating device includes a first power generating device and a second power generating device. The first power generating device includes a first shifting gear set that transmits to connect to the one-way driving strip 21, and a first power generator 40. The second power generating device includes a gravity driving strip 6 disposed on the inner cavity of the light pole 3, a second shifting gear set that transmits to connect to the gravity driving strip 6, a second power generator 41 and a rising mechanism for lifting the gravity driving strip 6;
wherein the one-way driving strip 21 and the back side of the gravity driving strip 6 are respectively hinged with a plurality of one-way ratchets 211 and a groove 22 for mounting the one-way ratchet 211;
wherein the first shifting gear set and the second shifting gear set are respectively a four-stage shifting gear set which consists of a first double-linking gear 51, a second double-linking gear 52, a third double-linking gear 53 and a fourth double-linking gear 54; the first double-linking gear 51 and the third double-linking gear 53 are coaxially arranged; the second double-linking gear 52 and the fourth double-linking gear 54 are coaxially arranged; the input gear of the first double-linking gear 51 is a ratchet wheel structure which meshes with the one-way driving strip 21; the output gear of the fourth double-linking gear 54 transmits to connect to the first power generator 40 and the second power generator 41, respectively;
wherein the rising mechanism includes a fixed pulley 7, a guiding pulley 70, a one-way reel 71 and a pulling rope 72 disposed at an upper portion of the inner cavity of the light pole 3; the pulling rope 72 sequentially winds the fixed pulley 7 and the guiding pulley 70, and the two ends of the pulling rope 72 are respectively connected with the gravity driving strip 6 and the one-way reel 71; the one-way reel 71 is disposed at the bottom of the one-way driving strip 21; the side of the one-way reel 71 is provided with a ratchet wheel 711 that is mutually driven with the one-way ratchet 211 on the one-way driving strip 21.

2. The environmentally-friendly street light with a multi-stage gear drive to generate electricity by using the public seat gravity potential energy of claim 1, wherein the rebound device is a spring rebound or cylinder rebound device.

3. The environmentally-friendly street light with a multi-stage gear drive to generate electricity by using the public seat gravity potential energy of claim 1, the gravity driving strip 6 is sildingly mounted on a guide sleeve 61 disposed in the base plate 1.

4. The environmentally-friendly street light with a multi-stage gear drive to generate electricity by using the public seat gravity potential energy of claim 1, wherein the bottom of the gravity driving strip 6 is provided with a weight 62.
